(19) United States
(12) Patent Application Publication
(10) Pub. No.: US 2019/0197878 A1
(43) Pub. Date: Jun. 27, 2019

(54) INTEGRATED VOICE OVER IP COMMUNICATION IN FIRE SYSTEMS

(71) Applicant: Autronica Fire & Security AS, Trondheim (NO)

(72) Inventor: Carlos Rubio Corredera, Trondheim (NO)

(21) Appl. No.: 16/229,862

(22) Filed: Dec. 21, 2018

(30) Foreign Application Priority Data
Dec. 21, 2017 (EP) 17382882.3

(51) Int. Cl. G08B 25/10; H04M 7/00; G08B 17/06; G08B 17/02; H04M 11/04

(52) U.S. Cl. CPC G08B 25/10; H04M 7/006; H04M 11/04; G08B 17/02; G08B 17/06

(57) ABSTRACT

A system for fire control and detection with integrated voice over internet protocol communication is provided. Aspects include alarm system devices which are respectively operable to detect various conditions within a predefined space and to take various actions relative to the various conditions within the predefined space. The alarm system devices are monitored by an alarm monitoring system and at least one of the alarm system devices includes a voice over internet protocol (VOIP) communication apparatus.

### CROSS-REFERENCE TO RELATED APPLICATIONS

This application claims the benefit of European Patent Application number 17382882.3 filed Dec. 21, 2017, which is incorporated herein by reference in its entirety.

### BACKGROUND

Exemplary embodiments pertain to the art of fire alarm and control systems and more specifically to integrated voice over IP communication in fire systems.

A typical alarm system for a building, such as an office building or an apartment building, has multiple types of detectors and alarms. These include smoke, heat and carbon monoxide detectors as well as fire and smoke alarms. In addition, the typical alarm system has a control center including multiple panels that can be operated to show a status of the alarm system as well as multiple individuals who are required to install and support the alarm system.

Typically, for live, technical support from an authorized or certified service provider, a technician will use a communication apparatus or a personal computer. In some cases, the support service provider telecommunication apparatus is not available or out of date (stickers in the front). Also, in some cases communication apparatus service coverage is an issue and access to a communication apparatus or a personal computer is not possible.

### BRIEF DESCRIPTION

Disclosed is a system for fire control and detection with integrated voice over IP communication. The system includes alarm system devices which are respectively operable to detect various conditions within a predefined space and to take various actions relative to the various conditions within the predefined space. The alarm system devices are monitored by an alarm monitoring system and at least one of the alarm system devices includes a voice over internet protocol (VOIP) communication apparatus.

In addition to one or more of the features described above, or as an alternative, further embodiments of the system may include that the VOIP communication apparatus is operable to communicate with the alarm monitoring system.

In addition to one or more of the features described above, or as an alternative, further embodiments of the system may include that the VOIP communication apparatus is operable to communicate with at least one other VOIP communication apparatus.

In addition to one or more of the features described above, or as an alternative, further embodiments of the system may include that the VOIP communication apparatus is operable to communicate with another alarm system device.

In addition to one or more of the features described above, or as an alternative, further embodiments of the system may include that the VOIP communication apparatus is configured in accordance with access-rights of a user.

In addition to one or more of the features described above, or as an alternative, further embodiments of the system may include that the alarm system devices comprise smoke, fire and carbon monoxide detectors, heat detectors, pull alarms, manual call points, sounders, strobes and relay modules.

Disclosed is alarm system for deployment in a building. The system includes alarm system devices distributed throughout an interior of the building, the alarm system devices being respectively operable to detect various conditions within the building and to take various actions relative to the various conditions within the building. The alarm system devices are monitored by an alarm monitoring system and at least one of the alarm system devices includes a voice over internet protocol (VOIP) communication apparatus.

In addition to one or more of the features described above, or as an alternative, further embodiments of the system may include that the alarm monitoring system is remote from the building.

In addition to one or more of the features described above, or as an alternative, further embodiments of the system may include that the VOIP communication apparatus is operable to communicate with the alarm monitoring system.

In addition to one or more of the features described above, or as an alternative, further embodiments of the system may include that the VOIP communication apparatus is operable to communicate with at least one other VOIP communication apparatus.

In addition to one or more of the features described above, or as an alternative, further embodiments of the system may include that the VOIP communication apparatus is operable to communicate with another alarm system device.

In addition to one or more of the features described above, or as an alternative, further embodiments of the system may include that the VOIP communication apparatus is configured in accordance with access-rights of a user.

In addition to one or more of the features described above, or as an alternative, further embodiments of the system may include that the alarm system devices comprise smoke, fire and carbon monoxide detectors, heat detectors, pull alarms, manual call points, sounders, strobes and relay modules.

Disclosed is a method of operating an alarm system integrated with voice over internet protocol deployed at a location in which alarm system devices are distributed to detect and to take various actions relative to various conditions within the location. The method includes installing an integrated VOIP system on each of the alarm system devices. A user input into the integrated VOIP system by a user is received at a first alarm system device and based at least in part on the user input, access-rights of the user are identified. A call is routed to a support system based at least in part on the user input and the access-rights of the user.

### BRIEF DESCRIPTION OF THE DRAWINGS

The following descriptions should not be considered limiting in any way. With reference to the accompanying drawings, like elements are numbered alike:

FIG. 1 depicts a block diagram of a computer system for use in implementing one or more embodiments;

FIG. 2 depicts a diagram of a system for integrated VOIP communication in a fire system according to embodiments; and

FIG. 3 depicts a diagram of a building with a system for VOIP communication in a fire system according to embodiments.

The diagrams depicted herein are illustrative. There can be many variations to the diagram or the operations described therein without departing from the spirit of the disclosure. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

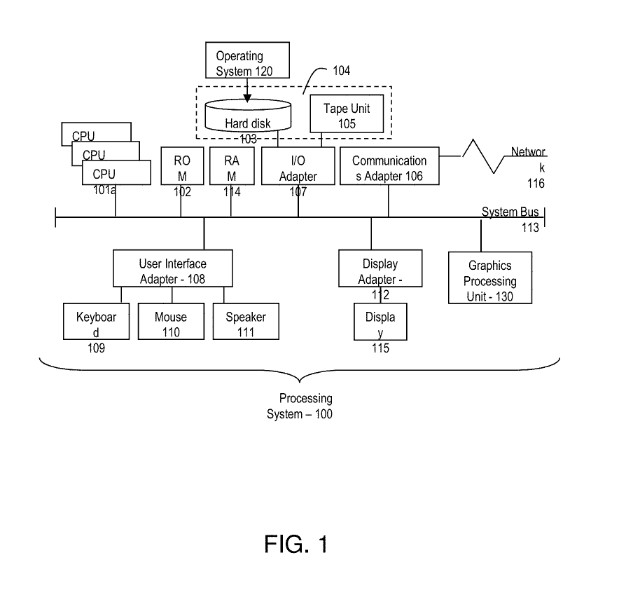

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more IVO busses that are connected to system bus 113 via an intermediate bus bridge (not shown). Suitable IVO buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 1.

Turning now to an overview of technologies that are more specifically relevant to aspects of the disclosure, fire systems include various system devices that can be deployed within a facility, such as an office building, and/or a vessel, such as a ship. Each system device performs specific tasks such as detection of smoke, fire, and carbon monoxide. A system device for a fire system can also include a control panel that communicates with the other devices and monitors the status of the fire system. Often, these system devices are distributed throughout a facility or vessel to maximize the detection of adverse conditions and alerting occupants of the facility or vessel as to any adverse conditions. These system devices require periodic maintenance to ensure proper operation. During maintenance, a support technician telecommunication apparatus is not always available or service might not be available in the specific location. Usage of cellular communication apparatuses can be problematic as system devices may be located in bad coverage areas or are blocked based on the location of the system device within the building or vessel (e.g., building basement).

Turning now to an overview of the aspects of the disclosure, one or more embodiments address the above-described shortcomings of the prior art by providing a system to integrate a voice over internet protocol (VOIP) service call capability into a fire system (e.g., fire alarm control panel, repeater panels, and control & monitoring stations).

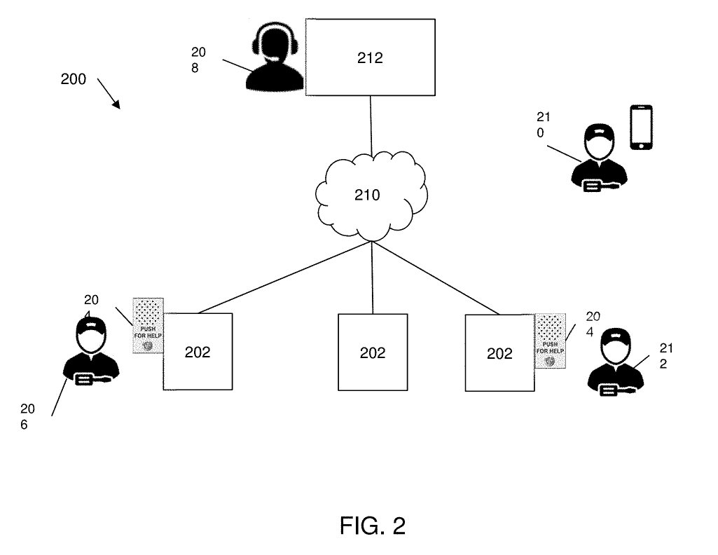

Turning now to a more detailed description of aspects of the present, FIG. 2 depicts a diagram of a system for integrated VOIP communication in a fire system according to embodiments. The system 200 includes alarm system devices 202, a network 210, and an alarm monitoring system 212. The alarm system devices 202 are in electronic communication with the alarm monitoring system 212. The alarm monitoring system 212 can be any type of alarm control and/or monitoring system such as, for example, an AutroMaster system. The alarm system devices 202 can be any type of alarm device such as, for example, a multi detector-occupancy-temperature-smoke (MDOTS) sensor mounted in a monitored space of a building or vessel. Additional alarm system devices 202 include but are not limited to smoke, fire and carbon monoxide detectors, heat detectors, pull alarms, manual call points, sounders, strobes and relay modules. The alarm system devices 202 can communicate with each other. For example, a control panel is communicative coupled to the various alarm system devices 202.

In one or more embodiments, the system 200 includes voice over internet protocol (VOIP) communication apparatuses 204 that are included with the alarm system devices 202. VOIP is a methodology and group of technologies for the delivery of voice communications and multimedia sessions over Internet Protocol (IP) networks, such as the Internet. A VOIP communication apparatus 204 uses voice over IP technologies for placing and transmitting telephone calls over an IP network, such as the Internet, instead of the traditional public switched telephone network.

In one or more embodiments, a service technician 206 can access the VOIP communication apparatus 204 at the alarm system device 202. The VOIP communication apparatus 204 can communicate over a network 210 to the alarm monitoring system 212 and to a technical support representative 208 controlling the alarm monitoring system 212. Additionally, the service technician 206 can communicate with a remote service technician 210 by utilizing the VOIP communication apparatus 204 to communicate with an electronic device such as another VOIP communication apparatus, a smart communication apparatus, tablet, or computer system. In one or more embodiments, the service technician 206 can utilize the VOIP communication apparatus 204 to communicate with a second service technician 212 that is located at another alarm system device 202 utilizing the VOIP communication apparatus 204 at the alarm system device 202. For example, a technician in a control room can communicate with a service technician that is investigating an issue around a facility or vessel.

In one or more embodiments, the alarm system devices 202 can provide access to a technician based on the identity of the service technician. For example, a low level service technician may only be allowed limited access to the VOIP communication apparatus 204, where the VOIP communication apparatus 204 can make calls to the alarm monitoring system 212 only. Higher level service technicians may be allowed full access allowing the higher level service technicians to make calls through the VOIP communication apparatus 204 to other VOIP communication apparatuses 214 on other alarm system devices 202 and to remote service technician 210 cell phones, for example. Also, the type of service technician accessing the VOIP communication apparatus 204, based on their identity, may have direct VOIP communication apparatus 204 calls to specific support technicians such as, for example, installers, distributor tech support, manufacturer support, emergency services, and the like. The fire alarm and control system can store in memory the specific support numbers or IP addresses to route the call depending on the user accessing the system. The number or IP addresses can be updated locally or remotely using remote services and connectivity to keep the correct information always up to date on the fire alarm and control system.

In one or more embodiments, the alarm system devices 202 and communication system 212 can be implemented on the processing system 100 found in FIG. 1. Additionally, the network 210 can be in wired or wireless electronic communication with one or all of the elements of the system 200. Cloud computing can supplement, support or replace some or all of the functionality of the elements of the system 200. Additionally, some or all of the functionality of the elements of system 200 can be implemented as a cloud computing node.

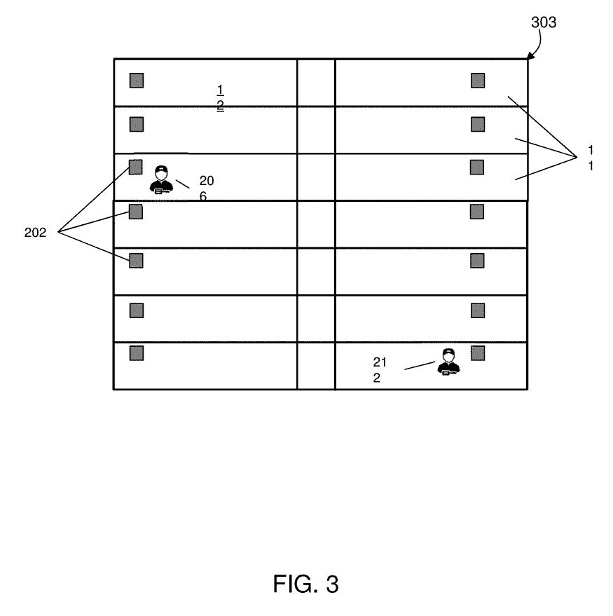

With reference to FIG. 3, a building 300 is provided and can include multiple floors 11 with multiple areas at each of the multiple floors 11 that together make up an interior 12 to the building 300. The building 300 includes a system for VOIP communication in a fire system 200. The system 200 includes various alarm system devices 202 that are distributed though the interior 12 of the building 300 and, in some cases, may also include an alarm monitoring system that may be local or remote with respect to the building 300. The alarm system devices 202 operate by detecting various conditions within the interior 12 of the building 300 and/or take various actions relative to those various conditions within the interior 12 of the building 300. To that end, the alarm system devices 202 may include, but are not limited to, smoke, fire and carbon monoxide detectors, heat detectors, pull alarms, manual call points, sounders, strobes and relay modules.

In one or more embodiments, the alarm system devices 202 include VOIP communication apparatuses as described herein. An authorized user, such as a service technician 206, can access the VOIP communication apparatuses at any of the alarm system devices 202. The VOIP communication apparatuses at the alarm system devices 202 can communicate with other VOIP communication apparatuses at other alarm system devices 202. This allows communication between a service technician 206 and another service technician 212 that may be on a different floor 11.

In each case and for most but not necessarily all types of the alarm system devices 202, the alarm system devices 202 are installed in various areas of the interior 12 of the building 300. Upon installation, each device may be configured for a certain detection or action purpose, and may be tested to determine that they are functioning as configured and intended. Each device may also be configured to provide certain information upon request.

A detailed description of one or more embodiments of the disclosed apparatus are presented herein by way of exemplification and not limitation with reference to the Figures.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system for fire control and detection with integrated voice over internet protocol communication, the system comprising:
alarm system devices which are respectively operable to detect various conditions within a predefined space and to take various actions relative to the various conditions within the predefined space; and
an alarm monitoring system by which the alarm system devices are communicative;
wherein at least one of the alarm system devices include:
a voice over internet protocol (VOIP) communication apparatus.

2. The system of claim 1, wherein the VOIP communication apparatus is operable to communicate with the alarm monitoring system.

3. The system of claim 1, wherein the VOIP communication apparatus is operable to communicate with at least one other VOIP communication apparatus.

4. The system of claim 1, wherein the VOIP communication apparatus is operable to communicate with another alarm system device.

5. The system of claim 1, wherein the VOIP communication apparatus is configured in accordance with access-rights of a user.

6. The system of claim 1, wherein the alarm system devices comprise smoke, fire and carbon monoxide detectors, heat detectors, pull alarms, manual call points, sounders, strobes and relay modules.

7. An alarm system for deployment in a building, the alarm system comprising:
alarm system devices distributed throughout an interior of the building, the alarm system devices being respectively operable to detect various conditions within the building and to take various actions relative to the various conditions within the building,
an alarm monitoring system by which the alarm system devices are communicative;
wherein at least one of the alarm system devices include:
a voice over internet protocol (VOIP) communication apparatus.

8. The alarm system of claim 7, wherein the alarm monitoring system is remote from the building.

9. The alarm system of claim 7, wherein the VOIP communication apparatus is operable to communicate with the alarm monitoring system.

10. The system of claim 7, wherein the VOIP communication apparatus is operable to communicate with at least one other VOIP communication apparatus.

11. The system of claim 7, wherein the VOIP communication apparatus is operable to communicate with another alarm system device.

12. The system of claim 7, wherein the VOIP communication apparatus is configured in accordance with access-rights of a user.

13. The system of claim 7, wherein the alarm system devices comprise smoke, fire and carbon monoxide detectors, heat detectors, pull alarms, manual call points, sounders, strobes and relay modules.

14. A method of operating an alarm system integrated with voice over internet protocol (VOIP) deployed at a location in which alarm system devices are distributed to detect and to take various actions relative to various conditions within the location, the method comprising:
installing an integrated VOIP system on each of the alarm system devices;
receiving a user input into the integrated VOIP system by a user at a first alarm system device;
based at least in part on the user input, identifying access-rights of the user; and
routing a call to a support system based at least in part on the user input and the access-rights of the user.
